(19) United States
(12) Patent Application Publication
(10) Pub. No.: US 2004/0199284 A1
(43) Pub. Date: Oct. 7, 2004

(54) Locker system

(76) Inventor: Shuhei Hara, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/626,572

(22) Filed: Jul. 25, 2003

(30) Foreign Application Priority Data
Mar. 3, 2003 (JP) 2003-055805

(51) Int. Cl. G06F 7/00

(52) U.S. Cl. 700/215

(57) ABSTRACT

A locker system of the present invention is capable of securing an available locker surely upon following necessary procedures for concluding a contract of utilization reservations of a home delivery locker as an address-for-delivery of a parcel or merchandize or so forth. The locker system comprises a plurality of lockers provided with predetermined operating means, a control center for consolidating the plurality of lockers, a delivery trader for delivering parcels to predetermined places according to predetermined measures of transportation, and a user terminal possessed by the user, in which the plurality of lockers, the control center, and the user terminal are connected via a communication line, wherein a parcel stored in an arbitrary locker from among the plurality lockers is made to deliver for an address-for-delivery specified by the user, and wherein the user selects any one of the plurality of lockers as an address-for-delivery of the parcel which the user himself desires to deliver and the user can specify to reserve the selected locker.

### BACKGROUND OF THE INVENTION

1. Field of the Invention

The present invention relates to a locker system provided with a plurality of functions, which enables a parcel recipient to receive a parcel surely so as to secure an available locker in its locker system as an address-for-delivery of the parcel or an objective for leaving the parcel on check.

2. Description of the Related Art

Nowadays, a delivery service of a postal delivery or a home delivery of a parcel becomes difficult gradually in multiple dwelling houses or a tenant building. These difficulties arise from high buildings, an increase of the number of dwelling houses or tenants in the same building, or plenitude of safety function, or so forth. It is ideal for a delivery person to deliver a mail or a home delivery parcel to the doorway of each dwelling house or each tenant surely. However, in many cases, a call for each of the door with a home delivery parcel is a troublesome matter caused by a structure of the building. Moreover, the delivery person must re-deliver the home delivery parcel, after bringing back the parcel once when a parcel recipient of an address-for-delivery is absent. Furthermore, it becomes more difficult for the delivery person to deliver the parcel or the mail to each doorway, in that there are taken measures for scheming plentitudes of anti-crime function in such a way as to limit going in and out itself of people to the building to prevent a crime by a false delivery trader.

In the ordinary case, there is installed a letter box in the vicinity of a doorway of the building for dwellers or the tenant thereof that can cope with small mail articles. However, a large mail article which can not be entered in the letter box, or a registered mail and a home delivery parcel which necessitate receipt stamps or so forth, both of which should be delivered to the door.

Accordingly, there is proposed a locker system called as a home delivery locker, and the home delivery locker is provided with an article storage section with a door which can be opened or closed by only predetermined operation.

The conventional locker system of this kind is installed in the vicinity of the doorway of the building. The locker system performs handling over of the articles between the user and the delivery person as well as the delivery trader and so forth via this article storage section. The locker system controls opening and closing of the door of the article storage section, upon performing certification of identifying the user himself or the specific delivery trader, who has concluded a contract with the locker system beforehand. The control of opening and closing of the door can be performed by using the magnetic card and so forth, and then the locker system issues a necessary delivery notification, a receipt, a temporary receipt or so forth.

Nowadays, the home delivery locker is installed in the vicinity of the doorway of the dwelling houses such as a mansion to receive the parcels delivered by the delivery agents and so forth. And the number of installation of the home delivery locker increases year by year. Such a home delivery locker does not only apply to an accommodation space such as a mansion and so forth, but also begins to be installed gradually at a public space of, for example, a business corporation, a station or an airport, a convenience store, and also educational institution such as a university, a library and so forth.

This home delivery locker has a computer built-in, and the computer is provided with a communication function. And the home delivery locker is connected to a control center with online connection in full-time via the communications line and so forth. Therefore, the control center can grasp utilization circumstances of each of the lockers, so that the complete measures with respect to security can protect this home delivery locker. Thus, the user can utilize the home delivery locker without anxiety, and the home delivery locker excels at convenience extremely.

However, conventionally, according to the locker system mentioned above, there is the problem that the user cannot utilize the home delivery locker actually. Because there is no available locker (there is no vacant locker). Namely, although the user desires to leave a parcel on check at the home delivery locker, the user desires to utilize a delivery service of a parcel while using the home delivery locker, or the user desires to specify the home delivery locker as an address-for-delivery of a parcel, the user cannot utilize the locker system actually.

Specifically, for instance, the delivery trader desires to leave, when the parcel recipient is absent, the parcel on check at the home delivery locker that is of unattended locker capable of storing the parcel. However, when there is no vacant locker actually, the delivery trader brings back the parcel once, and notifies information for the parcel recipient of guidance of a re-delivery arrangement by means of an absence delivery ticket or the telephone or so forth. The parcel recipient finds that the parcel cannot be delivered because of his absence based on confirmation of this absence delivery ticket or so forth. And then the parcel recipient instructs, while communicating the re-delivery to the contact address of the delivery trader described on the absence delivery ticket, the delivery trader to receive the parcel on the parcel acceptance date and its period of time. The delivery trader re-delivers the parcel at time of day desired by the parcel recipient based on the information about the re-delivery arrangement. According to this matter, there is the problem that, when there is no information about the re-delivery arrangement from the parcel recipient, it is not possible to complete delivery arrangement of the parcel in that implementation of the re-delivery arrangement of the parcel must wait for the information about the re-delivery arrangement from the parcel recipient.

Further, according to the home delivery locker described above, there is the problem that the number of turnover of utilization of the locker deteriorates significantly. The deterioration of the turnover arises from the fact that, generally, utilization time limits of the locker are not instituted. Accordingly, this causes the circumstance that the parcel checked once is left unattended, so that another user cannot leave a parcel on check at the home delivery locker.

Furthermore, a life-style of men of today involves the significant change-up than it used to be, therefore, following services are desired with respect to the locker system described above:

Service (1): A utilization contractor of the home delivery locker can leave the parcel on check at the home delivery locker installed at a station or a convenience store or so forth, and causes the parcel to be delivered for an address-for-delivery specified arbitrarily from the corresponding home delivery locker.

Service (2): A delivery trader can deliver the parcel, which has been stored in the locker specified initially as the address-for-delivery of the parcel by the utilization contractor of the home delivery locker, for an additional locker installed at a different location, or a different place.

Service (3): A delivery trader can deliver a parcel for an address-for-delivery of an additional home delivery locker while changing the address-for-delivery of the home delivery locker specified initially by the utilization contractor of the home delivery locker.

However, the majority of the conventional locker systems described above assumes that the user can receive the parcel at only one installation location (user's place of dwelling) of the home delivery locker, so that forwarding services of the parcel stored once is not performed under the present circumstances. Accordingly, there is the problem that the home delivery parcel stored in the locker once can only be received from this locker, therefore, even though the user desires to receive the parcel at an additional place different from that locker, it is not possible to receive the parcel too.

In addition, following services except for the above-described services are desired:

Service (4): A utilization contractor of a home delivery locker can specify the home delivery locker as an address-for-delivery of merchandize purchased at an on-line shopping or a net auction or so forth, and enables the parcel of the merchandize to be delivered for the corresponding locker.

Service (5): It is possible to cause the parcel to be delivered automatically to the home delivery locker installed in the vicinity of the user's home, upon reserving the locker as the address-for-delivery beforehand in order to receive the parcel at absent, even though the home delivery locker is not installed at the user's home.

However, according to the conventional locker system mentioned above, there is the problem that the parcel recipient is not necessarily receivable the parcel. This problem arises from the fact that the delivery trader cannot confirm previously the installation location of an available locker and/or utilization circumstances of the locker as the address-for-delivery of the parcel. Thus, it is not possible to complete the delivery of the parcel, when there is no vacant locker at the time the delivery trader delivers the parcel actually.

Moreover, according to the conventional locker system described above, there is the problem that the user cannot utilize, if the home delivery locker is not installed at the dwelling house of the user beforehand, the service of the locker system.

### SUMMARY OF THE INVENTION

The present invention is made in consideration of the above-described problems, and it is an object of the present invention to provide a locker system in which an available locker can be secured surely based on the user's utilization reservations of the home delivery locker as the address-for-delivery of the parcel or the merchandize or so forth.

Further, it is another object of the present invention to provide a locker system in which the delivery trader capable of securing the home delivery locker of the address-for-delivery surely, upon reserving utilization of the home delivery locker as the address-for-delivery of the parcel at the stage before practical delivery processing of the parcel.

Furthermore, it is still another object of the present invention to provide a locker system capable of improving utilization turnover of the home delivery locker installed at various places.

Moreover, it is still another object of the present invention to provide a locker system capable of forwarding the parcel stored in the locker once toward a required additional locker or a required additional place according to simple procedure and plain method.

Moreover, it is still another object of the present invention to provide a locker system capable of securing surely, when specifying the home delivery locker as the address-for-delivery of the parcel or the merchandize or so forth, the home delivery locker of the address-for-delivery upon specifying selectively the available locker, after confirming installation location of the available locker and/or utilization circumstances of the home delivery locker as the address-for-delivery.

According to a first aspect of the present invention, there is provided a locker system which comprises a plurality of lockers provided with predetermined operating means, and a control center for controlling the plurality of lockers, both of which are connected via a communication line network, wherein a utilization applicant of the locker accesses, when the user's requested locker is in busy condition, the control center from the predetermined operating means or an terminal apparatus available for the utilization applicant via the communication line network, and transmits utilization reservations signals of the locker and a contact address of the utilization applicant as reservations information. And the control center performs, when the user's requested locker becomes available, a utilization reservations operation of the locker, while transmitting locking instructions of the available locker, then notifies that the locker is available to the contact address of the utilization applicant. And the utilization applicant confirms that the locker is available based on the notification from the control center, then proceeds to the installation location of the corresponding locker, followed by unlocking the locked locker by using the predetermined operating means in order to leave a parcel on check at the locker.

According to a second aspect of the present invention, there is provided a locker system which comprises a plurality of lockers provided with predetermined operating means, and a terminal apparatus available for a utilization applicant of the locker, both of which are connected via a communication line network, wherein the utilization applicant of the locker transmits, when the user's requested locker is in busy condition, utilization reservations signals of the locker and a contact address of the utilization applicant to any one of the plurality of lockers from the predetermined operating means or the terminal apparatus via the communication line network. And each of the plurality of lockers has observing means for observing utilization circumstances of the locker, and communicating means for communication with the terminal apparatus. When the communicating means receives the utilization reservations signals and the contact address via the communication line network and the observing means finds that the user's requested locker becomes available, the observing means reserves this locker, while locking the corresponding locker, and the communicating means transmits a communication to the effect that the locker is available to the contact address. And then, the utilization applicant confirms that the locker is available by using the communicating means, and proceeds to the installation location of the corresponding locker, followed by unlocking the locked locker using the predetermined operating means in order to leave the parcel on check at the locker.

According to a third aspect of the present invention, there is provided a locker system which comprises a plurality of lockers provided with predetermined operating means, a control center for consolidating the plurality of lockers, a delivery trader for delivering parcels to predetermined places according to predetermined means of transportation, and a user terminal possessed by the user, in which the plurality of lockers, the control center, and the user terminal are connected via a communication line. When a parcel stored in an arbitrary locker is made to deliver for an address-for-delivery specified by the user, the user obtains information about the address-for-delivery from the control center beforehand and specifies the address-for-delivery of the parcel based on the obtained information using the predetermined operating means or the user terminal to transmit a communication about the specified address-for-delivery to the control center. While, the control center instructs the delivery trader on delivery of the parcel for the address-for-delivery from the locker based on the information of the address-for-delivery specified by the operating means or the user terminal, and the delivery trader executes collection of cargo of the parcel from the locker by using the transportation means based on the instruction for causing the parcel to be delivered for the address-for-delivery.

According to a forth aspect of the present invention, there is provided a locker system which comprises a plurality of lockers provided with predetermined operating means, a control center for consolidating the plurality of lockers, and a user terminal possessed by the user, all of which are connected via communication line, in which the user can select previously any one of the plurality of lockers as an address-for-delivery of the parcel which the user himself desires to deliver, and then the user can specify to reserve the selected locker, wherein the user requires to obtain information concerning a locker as the address-for-delivery by using the predetermined operating means or the user terminal, from the control center, and the control center transmits; in accordance with the requirement of the user, positional information and utilization circumstances of the locker as the address-for-delivery of the parcel to the locker or the user terminal so that the user selects to specify the required address-for-delivery of the parcel based on the positional information and the utilization circumstances, thus the user is capable of performing reservations specification of the required home delivery locker of the address-for-delivery.

According to a fifth aspect of the present invention, there is provided a locker system which comprises a plurality of lockers provided with predetermined operating means, a control center for consolidating the plurality of lockers, and a user terminal possessed by the user, all of which are connected via a communication line, wherein the user accesses the control center from the predetermined operating means or the user terminal, and concludes utilization contract of a locker as an address-for-delivery of parcels with the parcel recipient at absent based on utilization reservations information. While, the control center notifies the delivery company, which is involved in business cooperation with the control center, of positional information of the locker as the address-for-delivery of the parcel with the parcel recipient at absent, and the delivery company completes, when the parcel recipient of the address-for-delivery is absent at the time of delivery of the parcel, the delivery of the parcel based on the notified positional information of the locker as the address-for-delivery, and then, the locker notifies, when the parcel is stored, the user terminal that the parcel is stored based on the utilization contract information from the control center.

According to a sixth aspect of the present invention, there is provided a locker system which comprises a plurality of lockers provided with predetermined operating means, a control center for consolidating the plurality of lockers, and a user terminal possessed by the user, all of which are connected via a communication line, wherein the user accesses the control center from the predetermined operating means or the user terminal, and concludes utilization contract of a locker as an address-for-delivery of parcels with the parcel recipient at absent based on utilization reservations information. While, the control center notifies the delivery company, which is involved in business cooperation with the control center, of positional information of the locker as the address-for-delivery of the parcel with the parcel recipient at absent, and the delivery company completes, when the parcel recipient of the address-for-delivery is absent at the time of delivery of the parcel, the delivery of the parcel based on the notified positional information of the locker as the address-for-delivery, and then, the control center notifies, when confirming that the parcel is stored in the locker, the user terminal that the parcel is stored based on the utilization contract information.

Other and further objects and features of the present invention will be become obvious upon understanding of the illustrative embodiments about to be described in connection with the accompanying drawings or will be indicated in the appended claims, and various advantages not referred to herein will occur to one skilled in the art upon employing of the invention in practice.

### BRIEF DESCRIPTION OF THE DRAWINGS

FIG. 1 is a block diagram showing rough configuration of a locker utilization reservations system according to a first embodiment of the present invention.

FIG. 2 is a system diagram showing detailed configuration between locker control center and a plurality of lockers according to the first embodiment.

FIG. 3 is a flowchart showing a first operation example according to the first embodiment.

FIG. 4 is a flowchart showing a second operation example according to the first embodiment.

FIG. 5 is a system configuration diagram showing outline of the locker utilization reservations system according to the second embodiment.

FIG. 6 is a block diagram showing rough configuration of a delivery system of a parcel stored in a locker according to a third embodiment.

FIG. 7 is a sequence chart showing a first operation example of the delivery system of the parcel stored in the locker according to the third embodiment.

FIG. 8 is a diagram showing a display example of a portable telephone according to the third embodiment.

FIG. 9 is a sequence chart showing the second operation example of the delivery system of the parcel stored in the locker according to the third embodiment.

FIG. 10 is a diagram showing a display example of the locker according to the third embodiment.

FIG. 11 is a block diagram showing rough configuration of a reservations specification system of a home delivery locker of an address-for-delivery according to a fourth embodiment.

FIG. 12 is a sequence chart showing a first operation example according to the fourth embodiment.

FIG. 13 is a diagram showing a display example of the locker (display) in the first operation example.

FIG. 14 is a sequence chart showing a second operation example according to the fourth embodiment.

FIG. 15 is a diagram showing a display example of a user terminal (portable telephone) in the second operation example.

FIG. 16 is a block diagram showing a rough configuration of a reservations specification system of a home delivery locker of an address-for-delivery according to a fifth embodiment of the present invention.

FIG. 17 is a sequence chart showing an operation example of a reservations specification system of a home delivery locker of an address-for-delivery according to the fifth embodiment.

### DETAILED DESCRIPTION OF THE PREFERRED EMBODIMENTS

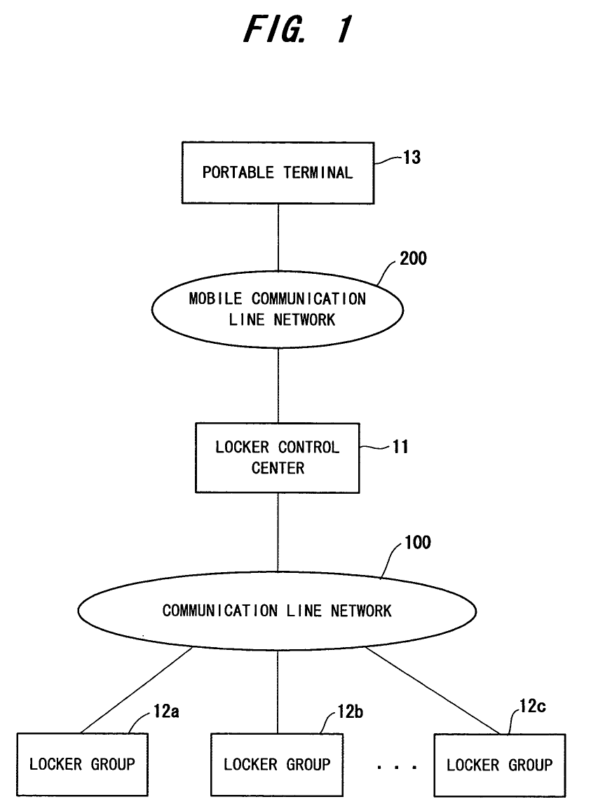

There will be described a locker utilization reservations system according to embodiments of the present invention in detail while referring to accompanying drawings below. FIGS. 1 to 5 show the locker utilization reservations system according to embodiments of the present invention.

(First Embodiment)

FIG. 1 is a block diagram showing rough configuration of the locker utilization reservations system according to the first embodiment of the present invention.

In FIG. 1, the locker utilization reservations system according to the first embodiment is comprised of a plurality of lockers 12a to 12n provided with communication facility, and a locker control center 11 which is connected to the plurality of lockers 12a to 12n via a communication line network 100. The locker control center 11 is connected to a portable terminals 13 (including portable telephones) possessed by locker utilization applicants (including delivery traders) via a mobile communication line network 200.

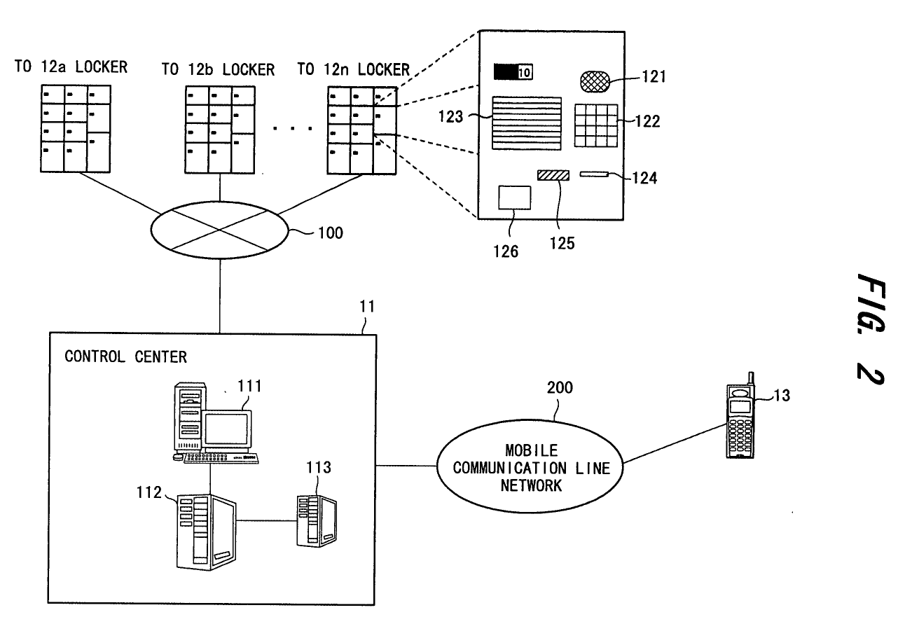

FIG. 2 is a system diagram showing detailed configuration between the locker control center 11 and the plurality of the lockers 12a to 12n. In FIG. 2, this locker control center 11 is comprised of a center terminal 111, a database server 112, and a backup server 113. In addition, the locker control center 11 is provided with operators (not shown) for performing a reception according to telephone function (telephone mouthpiece 121) mounted on respective lockers 12a to 12n.

The center terminal 111 observes, in real time, information of installation locations or contact addresses or so forth of a plurality of lockers 12a to 12n, personal information (legal name, room number, telephone number, and so forth) of an utilization contractor, locker utilization circumstances at present, anticrime control, and so forth. The database server 112 associates circumstances observed by the center terminal 111 with time information to store therein. Mirroring of the backup server 113 stores the same information as that stored in the database server 112, in an emergency, although interference occurs on the database server 112, system itself does not become down state because of the backup server 113.

Each of the plurality of lockers 12a to 12n is provided with a telephone mouthpiece 121 for performing telephone call with the operator (not shown) of the locker control center 11, an operation key group 122 for performing specification of an address-for-delivery or taking out of the parcel, a display 123 for displaying various kinds of information such as operation instruction and so forth from the locker control center 11, a card loading slot 124 for inserting a card (IC card, magnetic card and so forth) for certificating an operator at the time of leaving the parcel on check or taking out of the parcel, a bar code scan slot 125 for scanning the bar code added to the delivery ticket, and a receipt issuance opening 126 for issuing a receipt (delivery ticket) indicating completion of leaving the parcel on check at the locker.

The portable terminal 13 is of a portable telephone or a Personal Digital Assistance (PDA) possessed by the locker utilization applicant (including home delivery driver and so forth). The telephone number (mail address is also possible) of this portable telephone or the mail address of the portable terminal or so forth is utilized as reservations information at the time of utilization reservations operation described later. It should be noted that this portable terminal 13 is not necessarily to be limited to the PDA or the portable telephone. If a terminal apparatus is connectable to the locker control center 11, for instance, the terminal apparatus installed at the convenience store or so forth is preferably used.

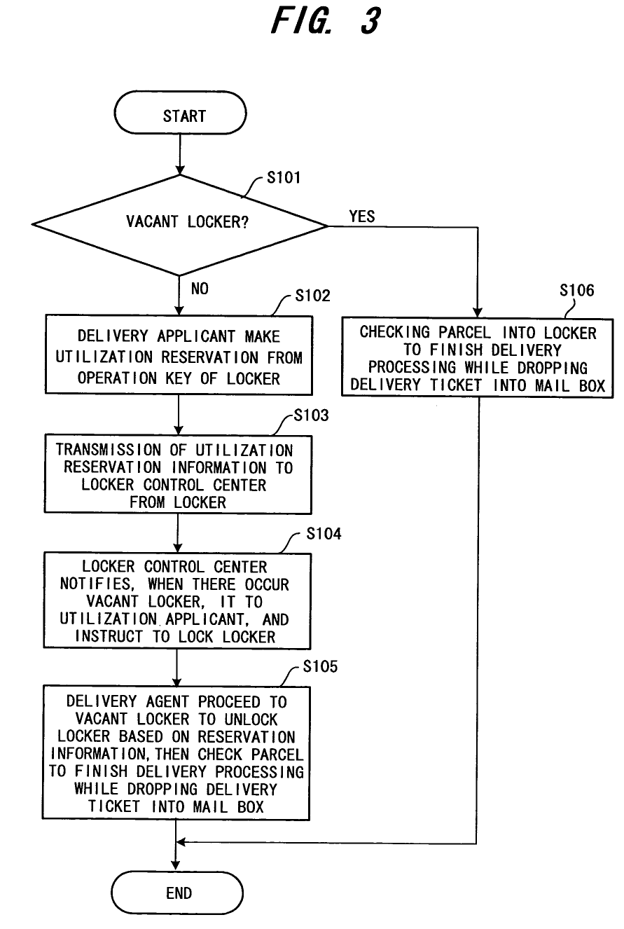

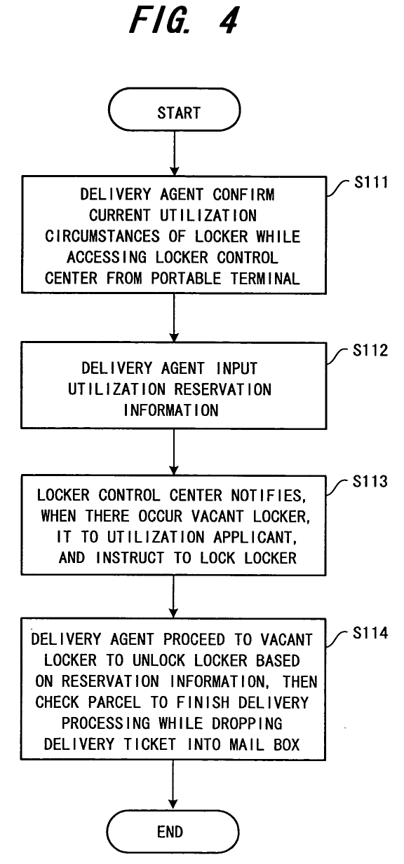

There will be described in detail operation example of the delivery trader who desires to leave the parcels on check at the home delivery locker while referring to FIGS. 3 and 4.

### FIRST OPERATION EXAMPLE

FIG. 3 is a flowchart showing the first operation example of the locker utilization reservations system according to the first embodiment of the present invention. The present operation example explains the case that the delivery trader proceeds actually to the locker as the address-for-delivery. It should be noted that the address-for-delivery here is the address of the user (parcel recipient) who has finished utilization contract of the home delivery locker beforehand and the locker as the address-for-delivery is installed in the dwelling houses (for instance, entrance hall of mansion) of this user.

Firstly, the delivery trader confirms whether to leave a parcel on check at the locker is possible or not while proceeding to the locker installed in the dwelling houses of the parcel recipient to be the address-for-delivery in order to leave the parcel on check at the locker (STEP S101). Here, when there is a vacant locker, the delivery person leaves the parcel on check at the locker, then terminates delivery processing while dropping a delivery ticket into a mail box (STEP S101/YES).

In STEP S1, when there is no vacant locker (STEP S101/NO), the delivery person performs utilization reservations operation from operating means mounted on any one of a door of the locker of the installed lockers (STEP S102).

The utilization reservations operation of the locker is capable of commencing in such a way that, for instance, there is provided “utilization reservations button” at the part within the operation key group 122 provided on the door of the locker, and then the delivery person depresses the utilization reservations button. The display 123 displays a reservations information input window, after depressing this utilization reservations button. The reservations information input here is of personal information (for instance, information for specifying person who is the delivery trader or license information in the case of individual) for specifying the person checking the parcel, and of contact address information such as the telephone number of the portable telephone or the mail address of the portable terminal possessed by the delivery trader to be a checking applicant of the parcels. After inputting the reservations information, the utilization reservation operation of the locker is completed, then reservations information is transmitted from the locker to the locker control center 11 (STEP S103).

The locker control center 11 always observes availability of the respective lockers in which the locker with the reservations information transmitted exists. The locker control center 11 notifies, when there appears a vacant locker, the contact address to the effect that there is a vacant locker by means of the voice message or the E-mail, and instructs locking processing of the locker to the vacant locker (STEP S104). Here, the delivery trader, who performs utilization reservations operation, inputs the contact address information based on the reservations information. The vacant locker itself locks the locker based on the locking instruction from the locker control center 11.

The delivery trader, who is notified from the locker control center 11 by the voice message or the E-mail to the effect that there is the vacant locker, proceeds to installation location of the vacant locker, followed by performing un-locking processing of the locker based on the reservations information (the personal information, the contact address information and so forth used at the time of the reservations), before performing to leave the parcel on check at the locker, and then he terminates delivery processing while dropping the delivery ticket into a mail box and so forth (STEP S105).

According to the first operation example of the present embodiment, when there is no vacant locker actually, after proceeding to the locker installation location, it is possible to perform utilization reservations operation on the spot, furthermore, the locker control center 11 notifies the delivery person immediately to the effect that the available vacant locker exists, at the stage of appearance of the vacant locker, therefore, it is possible to secure the locker that is one to which the parcel is capable of being delivered surely.

### SECOND OPERATION EXAMPLE

FIG. 4 is a flowchart showing the second operation example of the locker utilization reservations system according to the first embodiment of the present invention. The present operation example explains the case that the delivery trader performs utilization reservations operation at the stage, before actually proceeding to the locker as the address-for-delivery. It should be noted that, similar to the first operation example, the address-for-delivery here is the address of the user (parcel recipient) who has finished utilization contract of the home delivery locker beforehand and the locker as the address-for-delivery is installed in the dwelling houses (for instance, entrance hall of mansion) of this user.

Firstly, the delivery trader confirms, at the stage before actually proceeding to the locker as the address-for-delivery, utilization circumstances of the locker of the address-for-delivery from the portable terminal 13 or the computer not shown (delivery control center terminal), which is mounted on the delivery trader (delivery company), capable of communicating to the locker control center 11 via communication line network 100 (STEP S111). Upon granting the utilization license beforehand between the locker control center 11 and the delivery trader (delivery company), it is possible to allow smooth access (elimination of certification processing) to the system.

The delivery trader confirms a currently utilizable locker (requested address-for-delivery) on the home page (Web) provided for the locker control center 11, and inputs, when the currently utilizable locker does not exist or after confirmation to the effect that the locker is currently utilizable, utilization reservations information of the locker (STEP S112). The utilization reservations information here is the same as the reservations information described above, such as personal information for specifying the delivery trader of the parcel, and contact address information of the telephone number of the portable telephone possessed by the delivery trader or the mail address of the portable terminal. It should be noted that it is possible to communicate to the actual delivery trader via the terminal of the delivery company. After inputting the reservations information, it is possible to complete utilization reservations operation of the locker on the Web. Also, it should be noted that it is possible to perform utilization reservations operation similarly from the portable terminal possessed by the delivery trader (delivery driver) as described above.

The locker control center 11 always observes individual utilization circumstances of the lockers to which there was a utilization application in accordance with the utilization reservations information. The locker control center 11 notifies, when there appears vacant locker, the contact address based on the contact address information to the effect that there is vacant locker by means of the voice message or the E-mail, and instructs locking processing of the locker to the vacant locker (STEP S113). The vacant locker itself locks the locker based on locking instruction from the locker control center 11.

The delivery trader who is notified from the locker control center 11 by the voice message or the E-mail to the effect that there is the vacant locker, proceeds to installation location of the vacant locker, followed by performing un-locking processing of the locker based on the reservations information (the personal information, the contact address information and so forth used at the time of the reservations), before performing to leave the parcel on check at the locker, the delivery trader finishes delivery processing while dropping a delivery ticket into a mail box and so forth (STEP S114).

It is preferable that the delivery trader causes the vacant locker information to be transmitted to the portable terminal 13 possessed by himself from the locker control center 11 directly, and also he causes the information to be transmitted to the portable terminal 13 possessed by himself from the computer (not shown) installed at the delivery company.

According to the second operation example, the delivery trader is capable of securing the locker as the address-for-delivery at the stage before delivering the parcel actually, therefore, it is possible to reduce transport cost in that the delivery trader can save labor of re-delivering, after bringing back the parcel once caused by the absence delivery as the conventional manner.

In addition, in the present embodiment, the locker control center 11 transmits, when there exists the parcel left unattended more than predetermined time in the locker, the voice message or the E-mail persuading the user with utilization contract of the locker to take out the parcel automatically. By this means, this makes it possible for the users to provide a lot of utilizable lockers, furthermore, it becomes possible to improve turnover of the locker utilization extremely.

In addition, in the above-described the first and the second operation examples, when there is no utilization of the locker by the user with the utilization reservations application in spite of elapse of predetermined time (for instance, degree of 2 hours) the locker control center 11 dissolves utilization reservations operation automatically (unlocking the locker), so that it is possible to carry on the locker system without lowering turnover of locker utilization.

(Second Embodiment)

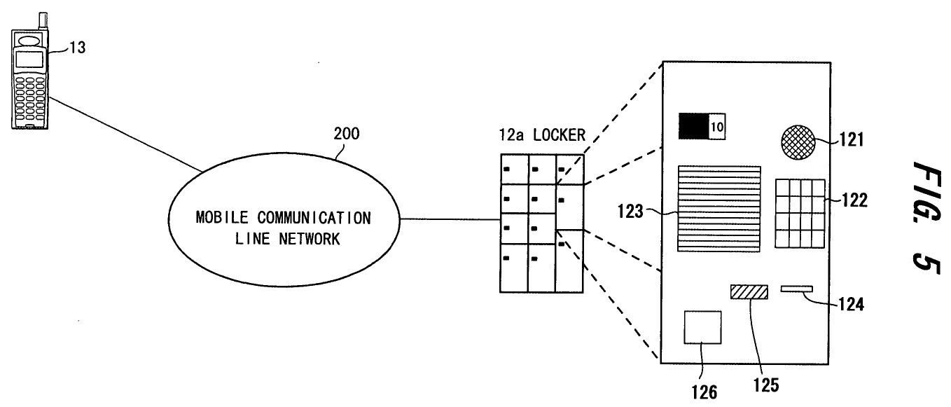

FIG. 5 is a system configuration diagram showing outline of a locker utilization reservations system according to a second embodiment of the present invention. In FIG. 5, the locker utilization reservations system according to the second embodiment is of locker 12a, in which the locker 12a is connected to the portable terminal 13 via the mobile communication line network 200. The present second embodiment differs from the above-described first embodiment in that the locker itself performs utilization reservations operation of the locker by self-completion processing except for the locker control center.

Similar to the first embodiment, each locker which constitutes the locker 12a is provided with predetermined operating means in front thereof, and also the locker is provided with observation function for always observing utilization circumstances or so forth of the lockers, and communicating function for communication with the portable terminal 13 via the mobile communication line network 200.

Firstly, the utilization applicant performs, when the utilization applicant of the locker desires to leave the parcel on check at the locker 12a with the whole lockers occupied, the utilization reservations operation of the locker from the predetermined operating means mounted on the locker 12a. The reservations information here is the same as that described above in the first embodiment.

Next, the locker 12a with the utilization reservations operation received always observes utilization circumstances of the locker depending on the observing function, and when there appears a vacant locker, the locker 12a performs locking of the vacant locker, followed by notifying the contact address (the portable terminal 13) to the effect that there is a vacant locker by means of the voice message or the E-mail. Here the contact address is input by the utilization applicant who requests the utilization reservations operation based on the above-described reservations information.

The locker utilization applicant proceeds to, when the locker 12a notifies signals to the effect that there is the vacant locker by means of the voice message or the E-mail, the installation location of the vacant locker, and performs unlocking of the locker based on the reservations information (personal information, contact address information and so forth) used at the time of reservations operation, then he leaves the parcel on check at the locker.

According to the second embodiment of the present invention, it is possible to perform the utilization reservations operation of the locker except for the locker control center, namely it is possible to construct the utilization reservations system of the self-completion type. In addition, when the parcel exists left unattended more than predetermined time in the locker, the locker 12a preferably transmits the voice message or the E-mail persuading the user with utilization contract of the locker to take out the parcel automatically.

It should be noted that the above-described embodiment of the invention is not limited to the description of delivery processing of the parcel according to the delivery trader, but ordinary user is capable of utilizing the locker system.

In addition, at the time of the utilization reservations operation of the locker, it is possible to perform utilization reservations operation using magnetic card or IC card possessed by the delivery trader, and also when performing unlocking processing of the locker, it is possible to utilize the magnetic card or the IC card.

Furthermore, in the case of the utilization reservations operation by an individual, it is possible to use information with personal information recorded in regular credit card as a part of reservations information, and it is also possible to utilize the card for performing unlocking processing properly.

As described above, according to the embodiments, it is possible to secure utilizable locker surely upon performing utilization reservations operation while waiting for appearance of the vacant locker in order to obtain the address-for-delivery of the parcel or merchandize.

In addition, according to the embodiment, it is possible to secure the home delivery locker of an address-for-delivery upon performing the utilization reservations operation of the locker as the address-for-delivery, at the stage before actually performing the delivery processing of the parcel by the delivery trader, therefore, it is possible to reduce waste cost (transport cost) upon eliminating unnecessary re-delivery processing at the side of the delivery trader.

Furthermore, according to the embodiment, it is possible to improve turnover of utilization of the locker upon urging the user to take out the parcel while notifying the user to the effect that the parcel is left unattended within the locker.

(Third Embodiment)

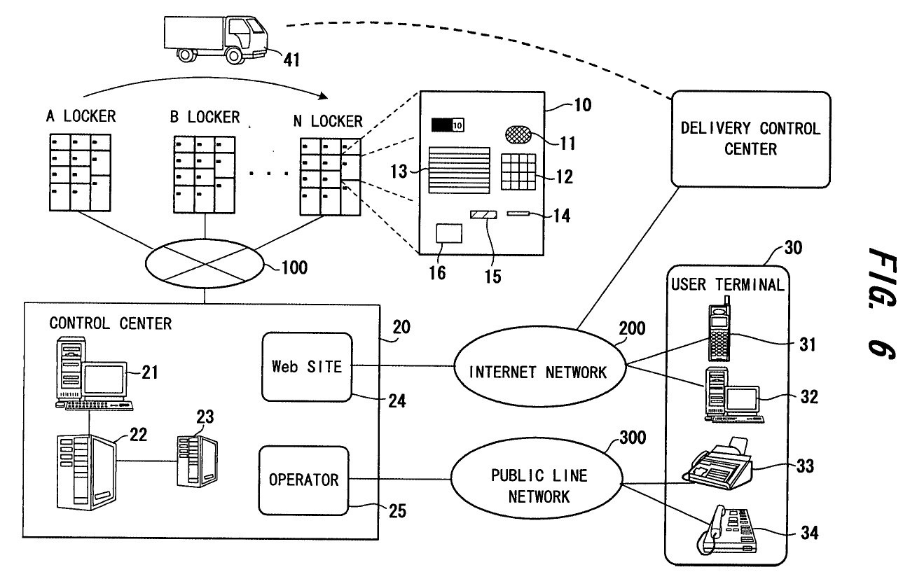

There will be described a delivery system of a parcel stored in a locker according to a third embodiment in detail referring to accompanying drawings below. FIGS. 6 to 10 show the delivery system of the parcel stored in the locker according to the third embodiment of the present invention.

FIG. 6 is a block diagram showing rough configuration of the delivery system of the parcel stored in the locker according to the third embodiment of the present invention. In FIG. 6, the delivery system of the parcel stored in the locker according to the third embodiment of the present invention is comprised of a plurality of locker group A to N, a control center 20 which is connected to the plurality of locker group A to N via a communication line network (leased line or public line) 100, a user terminal 30, a delivery control center 40 which is connected to the control center 20 via an internet network 200. It should be noted that FIG. 6 shows that the parcel stored in the locker group A is forwarded to the locker group N, however, the address-for-delivery is not necessarily to be limited to the locker, thus it is preferable to forward the parcel toward the address specified arbitrarily.

The locker 10 is provided with a telephone mouthpiece 11 for making telephone call with the operator 25 of the control center 20, an operation key group 12 for performing specification of the address-for-delivery or taking out of the parcel, a display 13 for displaying various kinds of information such as operation instruction and so forth from the control center 20, a card loading slot 14 for inserting a card (IC card, magnetic card or so forth) for certificating the operator at the time of leaving the parcel on check at the locker or taking out the parcel from the locker, a bar code scan slot 15 for scanning the bar code added to the delivery ticket, and a receipt issuance opening 16 for issuing a receipt (delivery ticket) indicating completion of the work for leaving the parcel on check at the locker or taking out the parcel from the locker.

The control center 20 has a center terminal 21, a database server 22 and a backup server 23. In addition, this control center 20 is provided with Web site 24 for performing the forwarding service of the parcel and the operator 25 for performing a reception according to telephone function provided on the locker 10.

The center terminal 21 observes, in real time, information of installation location or contact address or so forth of a plurality of lockers group A to N, personal information (legal name, room number, telephone number, and so forth) of an utilization contractor, locker utilization circumstances at present, anticrime control, and so forth.

The database server 22 associates circumstances observed by the center terminal 21 with time information to store therein. The backup server 23 stores the same information as that stored in the database server 22, by this means, in an emergency, although interference occurs on the database server 112, system itself does not become down state because of the backup server 23.

The user terminal 30 is of, for instance, a portable telephone (PDA is possible) 31 or a personal computer terminal 32 capable of accessing Web site 24 which the control center 20 performs administrative control, connected via the internet network 200, the facsimile apparatus 33 or the fixed telephone set 34 capable of communicating with the operator 25 of the control center 20 via the public line network 300.

The delivery control center 40, which is connected to the control center 20 via the internet network 200, and is controlled by the delivery trader, performs control of delivery processing of the parcel for the address-for-delivery specified by the user. It is preferable that this delivery control center 40 is managed by, for instance, the home delivery trader and so forth, and it is possible that taxi company performs delivery processing of the parcel using the network while aiming at increase of the number of taxi in recent years.

In addition, the delivery control center 40 is provided with communication function for realizing interactive connection with the delivery car (plural delivery cars) 41 for delivering the parcel actually. This delivery car 41 has the GPS (Global Positioning System) on board to always inform current position of own car to the delivery control center 40, so that the delivery control center 40 is capable of finding that the delivery car 41 works at which position currently.

It should be noted that the delivery trader is not necessarily to provide the above-described delivery control center, and it is possible to perform delivery arrangement of the parcel based on delivery instruction according to the telephone or the FAX as in the past, in addition, it is preferable that the delivery trader is one who is managed by the control center 20 for controlling the locker.

### FIRST OPERATION EXAMPLE

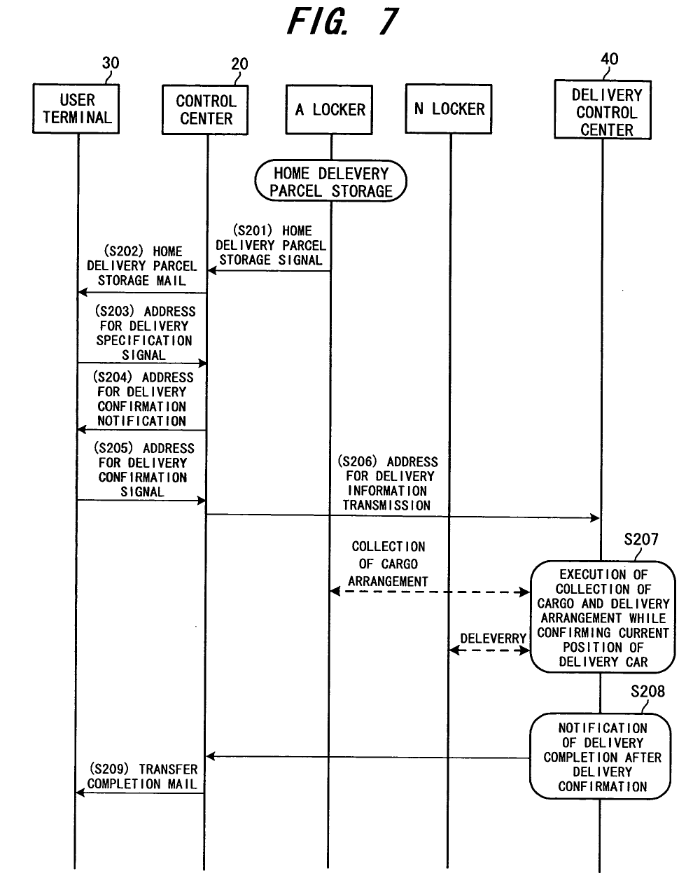

FIG. 7 is a sequence chart showing the first operation example of the delivery system of a parcel stored in a locker according to the third embodiment of the present invention. The present operation example explains that the user instructs to forward the parcel stored in the locker (referred to as locker group A) installed at the dwelling house (multiple dwelling houses such as mansion and so forth) of the user to the additional locker group N installed at another location by using the portable telephone possessed by the user. It should be noted that the user of the present system has concluded utilization contract of the present system beforehand with the control center 20.

Firstly, the locker group A transmits a home delivery parcel storage signal indicating that home delivery parcel is stored in the locker, while using communication function, to the control center 20 when the home delivery parcel is stored (STEP S201).

The control center 20 transmits, when receiving the home delivery parcel storage signal from the locker group A to which the home delivery parcel is stored, E-mail indicating that the home delivery parcel is stored to the portable telephone 31 of the user to be a parcel recipient of the home delivery parcel stored in the locker group A (STEP S202).

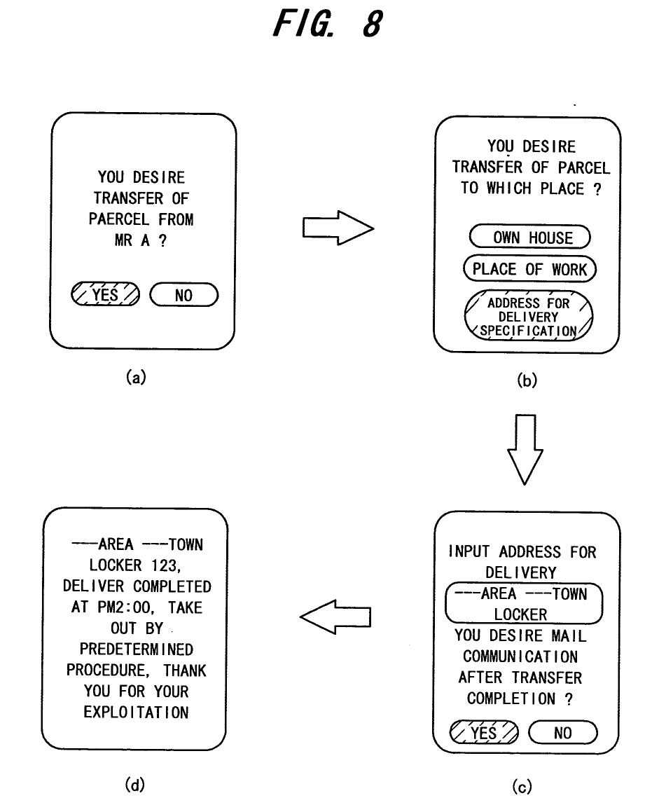

The user, who receives E-mail indicating that the home delivery parcel is stored, selects to access hyper-link (“address-for-delivery specification” in FIG. 8(b)) to the Web site 24 attached on the E-mail displayed on display window of the portable telephone 31. The user transmits the data of the locker group N as the specification information of the address-for-delivery of the parcel to the control center 20 via the Web site 24 on the window of “address-for-delivery specification”, in the case that the user desires to forward the parcel toward the locker group N in the vicinity of the company that he serves (STEP S203).

The control center 20 confirms instantaneously whether or not any of the locker, which constitutes the locker group N specified by the user, is vacant state, while referring to the database server 22. The control center 20 makes the locker reservations condition upon locking the locker, when being vacant condition, and transmits acknowledgement signal for reconfirmation of the address-for-delivery to the user terminal 30 (STEP S204). It should be noted that, in the case that there is no vacant locker at the locker group N as the address-for-delivery specified by the user, it is preferable to adopts method to transmit message for urging the user to specify another locker, or to introduce another locker group positioned in the vicinity of the locker specified by the user.

The user confirms acknowledgement signal of the address-for-delivery confirmation transmitted from the control center 20, subsequently transmits confirmation signal from the portable telephone 31 to the control center 20 if there is no error about the address-for-delivery specified (STEP S205).

The control center 20 receives the address-for-delivery confirmation signal from the portable telephone 31, then transmits the address-for-delivery information specified by the user toward the delivery control center 40 (STEP S206).

The delivery control center 40 obtains current position of each delivery car, while utilizing the GPS system mounted on the delivery car, and makes inquires whether or not collection of cargo is possible to the delivery car 41, which performs work at the most closest point to the locker group A at which the home delivery parcel is stored initially. The delivery control center 40 issues the collection of cargo instruction to the delivery car 41 if the collection of cargo is possible. Supposing that the delivery car 41 cannot perform the collection of cargo, the delivery control center 40 makes inquires to the next delivery car at the next close point to the locker group A so as to take a step to prepare the delivery car capable of processing the collection of cargo effectively with the most speedy action.

According to the above operation, the delivery control center 40 arranges the delivery car 41 capable of performing the collection of cargo, then performs the collection of cargo of the home delivery parcel from the locker group A to which the home delivery parcel is stored initially, and then executes delivery processing of the parcel to the locker group N as the address-for-delivery specified by the user (STEP S207). It should be noted that, on the occasion of the reservations operation of collection of cargo of the home delivery parcel from the locker group A, it is preferable that information such as necessary password to open the locker group A is transmitted at the same time the delivery control center 40 transmits the collection of cargo arrangement to the delivery car 41.

In addition, it is preferable that necessary password or IC card to unlock the locker is given previously upon performing contract cooperation between the control center 20 and the delivery control center 40 beforehand.

The delivery control center 40 informs the control center 20 to the effect that the delivery processing is completed, when there is the information to the effect that the delivery processing toward the locker group N as the address-for-delivery is completed from the delivery car 41 (STEP S208).

The control center 20 transmits, when the delivery control center 40 notifies that the forwarding of the home delivery parcel is completed, a communication using E-mail to the effect that the forwarding of the home delivery parcel is completed to the user of the portable telephone 31 who desires the forwarding of the home delivery parcel (STEP S209).

FIG. 8 is a diagram showing display example of the portable telephone in the present operation example.

Firstly, as shown in FIG. 8(a), the window transmitted from the control center 20 indicates the message notifying that the home delivery parcel is delivered to the locker group A, and the acknowledgement message whether or not forwarding processing of the parcel delivered is desired. The user, who confirms the window, selects “YES” when the user desires the forwarding of the home delivery parcel, while when the user does not desire the forwarding, the user selects “NO”. Here, when the user selects “NO”, the home delivery parcel is stored in the locker group A as it is, therefore, the user can perform taking out of the home delivery parcel, upon performing predetermined un-locking operation while proceeding to the installation location of the locker group A.

Next, FIG. 8(b) shows the window in the case that the user selects “YES” to desire forwarding of the home delivery parcel. The window displays the message for confirming that the home delivery parcel is forwarded to which location, and three kinds of selections of “own house”, “place of work”, and “address-for-delivery specification” are prepared. When the user selects “own house” or “place of work”, since these are information registered at the time of utilization contract of the system beforehand, it is possible to specify the address-for-delivery without performing specific input operation.

FIG. 8(c) shows the window in the case of the user's selection of “address-for-delivery specification”, in which the address-for-delivery of the home delivery parcel is made to specify specially. The window displays a window for inputting the address-for-delivery desired by the user, and confirmation message whether or not a mail for indicating completion of the delivery toward the specified address-for-delivery is desired. The user inputs, on this window, information of “----area, ----town, locker” of the locker existing in the vicinity of the company to which he serves, and desires delivery completion mail at the time delivery toward the locker is completed. It should be noted that, in the present operation example, the user specifies the locker as the address-for-delivery, however it is possible that required address is taken to as the address-for-delivery while inputting the required address. In addition, it is preferable to institute input window of delivery request time.

FIG. 8(d) shows a delivery completion window indicating that forwarding processing of the home delivery parcel is completed. The window displays the location of the locker as the address-for-delivery and the number “----area, ----town, locker 123” specified by the user, therefore, the user can confirm that the home delivery parcel is stored in the locker specified by himself.

### SECOND OPERATION EXAMPLE

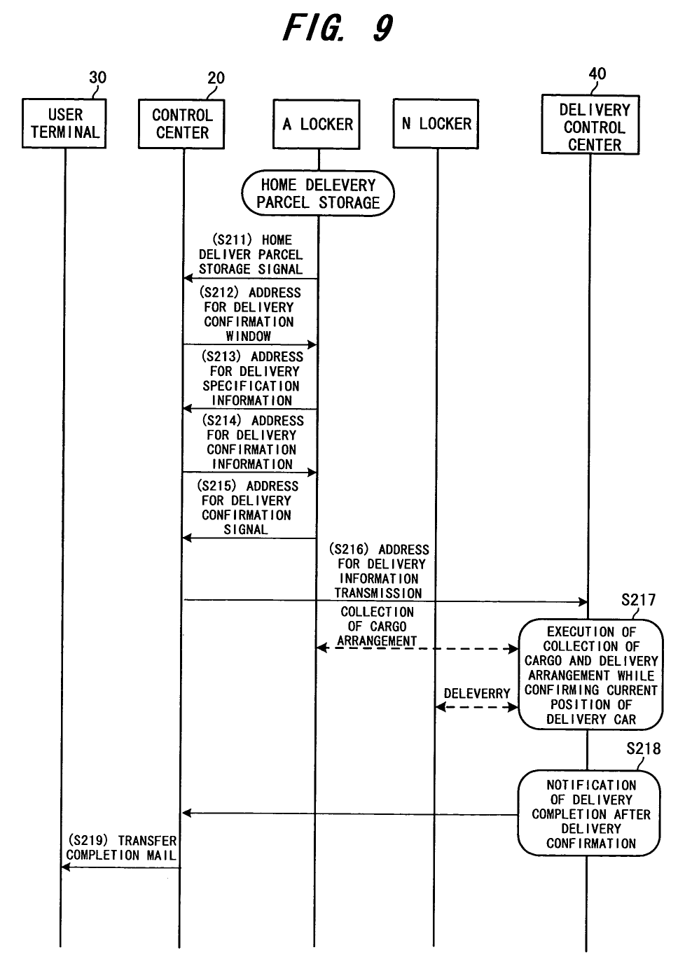

FIG. 9 is a sequence chart showing a second operation example of the delivery system of the parcel stored in the locker according to the third embodiment of the present invention. The present operation example explains the case in which the user performs forwarding instruction using the display and/or the operation key group provided at the locker that stores the parcel. The user himself who leaves the parcel on check at the locker (referred to as the locker group A) once, and the user causes the parcel to be delivered toward the additional locker group N installed at another location. It should be noted that, similar to the first operation example, the user of the present system concludes utilization contract of the present locker system with the control center 20 beforehand.

Firstly, when the user leaves the parcel on check at the arbitrary locker of the locker group A, the locker group A transmits the home delivery parcel storage signal indicating that the home delivery parcel is stored in the locker to the control center 20 using communication function (STEP S211).

The control center 20 transmits, when receiving the home delivery parcel storage signal from the locker group A to which the parcel is stored, the address-for-delivery confirmation window of the parcel to the locker group A (STEP S212).

The user inputs, after confirming display of the locker on which the address-for-delivery confirmation window transmitted from the control center 20 is indicated, required address-for-delivery information via the operation key group in order to transmit the input information to the control center 20 as the specification information of the address-for-delivery (STEP S213). It should be noted that the control center 20 can provide, at the time of specification of the address-for-delivery (locker), the installation location of the locker in the vicinity of the address-for-delivery required by the user and vacant circumstances and so forth as a view map, therefore, it is possible for the user to easily perform input operation of the address-for-delivery.

The control center 20 confirms instantaneously whether or not any of the locker, which constitutes the locker group N specified by the specification information of the address-for-delivery, is of vacant condition, while referring to the database server 22. At the time the control center 20 receives the specification information of the address-for-delivery from the locker (locker group A) to which the parcel is stored, and then the control center 20 makes the locker reservations operation condition upon locking the locker in the case of vacant condition. The control center 20 transmits, after making the locker of the address-for-delivery reservations operation condition, the address-for-delivery confirmation notification for confirming whether or not the specification information of the address-for-delivery is correct to the locker group A (STEP S214). It should be noted that, in the case that there is no vacant locker at the locker group N of the address-for-delivery specified by the user, it is preferable to adopts method to transmit message for urging the user to specify another locker, or to put the user onto another locker group positioned in the vicinity of the locker specified by the user.

The user transmits, after confirming the address-for-delivery confirmation notification transmitted from the control center 20, the address-for-delivery confirmation signal to the control center 20 from the locker (locker group A) to which the parcel is stored if there is no error about the specified address-for-delivery (locker group N) (STEP S215).

The control center 20 transmits, when receiving the address-for-delivery confirmation signal transmitted from the locker group A, the address-for-delivery information specified by the user to the delivery control center 40 (STEP S216).

The delivery control center 40 obtains the current position of each of the delivery cars while utilizing the GPS system mounted on the delivery car, and makes inquires whether or not the collection of cargo is possible to the delivery car 41 which performs work at the most closest point to the locker group A at which the home delivery parcel is stored initially. Then, the delivery control center 40 issues, if the collection of cargo is possible, instructions of the collection of cargo to the delivery car 41. Supposing that the delivery car 41 cannot perform the collection of cargo, the delivery control center 40 makes inquires to the next delivery car at the next close point to the locker group A so as to arrange the delivery car capable of processing effectively the collection of cargo with the most speedy action.

According to the above operations, the delivery control center 40 arranges the delivery car 41 capable of performing the collection of cargo, then performs the collection of cargo of the home delivery parcel from the locker group A to which the home delivery parcel is stored initially, followed by executing the delivery processing of the parcel to the locker group N as the address-for-delivery specified by the user (STEP S217). It should be noted that, the necessary information on the occasion of the collection of cargo of the home delivery parcel from the locker group A is handled in the same way as that of the first operation example.

The delivery control center 40 notifies, when there is the information to the effect that the delivery processing to the locker group N as the address-for-delivery is completed from the delivery car 41, the control center 20 to the effect that the delivery processing is completed. (STEP S218).

The control center 20 transmits, when the delivery control center 40 notifies the control center 20 of the completion of the delivery, the forwarding completion mail to the mail address of the user terminal 30 that has been registered at the time of utilization contract by the user who desired the forwarding of the parcel (STEP S219). It should be noted that in the case that the user refuses information of the forwarding completion mail, it is not necessarily need of transmission.

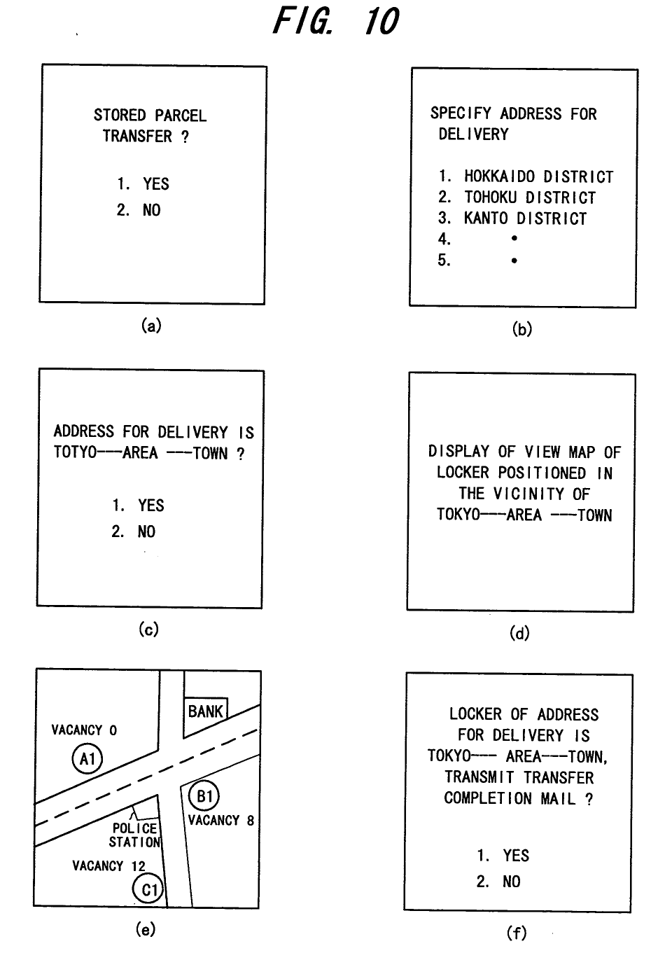

FIG. 10 is a diagram showing a display example of the locker in the present operation example.

Firstly, as shown in FIG. 10(a), there is displayed an inquiry whether or not forwarding of the parcel stored in the locker of the locker group A is desired on the window transmitted from the control center 20. The user, who confirms the window, selects “1. YES”, when the user desires forwarding of the parcel, while when the user does not desire forwarding of the parcel, the user selects “2. NO”. Here, the user selects “2. NO”, the parcel remains to be stored in the locker of the locker group A.

Next, FIG. 10(b) shows the window in the case that the user selects “1. YES” when the user desires forwarding of the parcel. The window displays name of a district as the address-for-delivery of the parcel, and the indicated information has hierarchical structure such as “name of a district→name of prefectures→name of a city→name of a house number”, therefore, it is possible to simply specify the address-for-delivery. The user can narrow down the address-for-delivery from among alternatives displayed, therefore, it is possible to reduce labor hour for inputting the dwelling place remarkably. Such information narrowed down is transmitted to the control center 20 as the specification information of the address-for-delivery. Furthermore, it is preferable to adopt a method that the user himself inputs information of the address-for-delivery.

FIG. 10(c) shows a confirmation window of the district of the address-for-delivery specified by the specification information of the address-for-delivery. The user specifies, when there is no error in contents displayed on the confirmation window, the district of address-for-delivery while selecting “1. YES”.

FIG. 10(d) shows the message window for displaying a view map of the district of address-for-delivery specified by the specification information of the address-for-delivery. This view map is convenience in the case that the user desires to specify the locker as the address-for-delivery, although the use cannot know that the locker exists at which location, or in the case that the user has specified the locker as the address-for-delivery, however the locker is in use condition. In addition, this view map is capable of being provided also in the case that the user accesses to the control center 20 while utilizing the portable telephone or the PDA.

FIG. 10(e) shows the view map in the vicinity of the address-for-delivery based on the specification information of the address-for-delivery specified by the user. The respective lockers indicated on this view map have locker IDs (A1, B1, C1 and so forth) which are of different alphabetical letters or numerical characters. The user is capable of specifying, when specifying the locker of the address-for-delivery, the address-for-delivery efficiently in that it is not necessary to perform the input specification in detail upon inputting these locker IDs. In addition, it is possible to secure the locker as the address-for-delivery surely because the respective lockers displayed on the view map display simultaneously current vacant circumstances.

FIG. 10(f) shows detailed information of the locker of an address-for-delivery. This window displays a location and a number “---area, ---town, B1” of the locker of the address-for-delivery specified by the user, therefore the user can confirm that the parcel is delivered to which locker. In addition, the window displays message for inquiring whether or not forwarding completion mail is desired on the occasion that the forwarding of the parcel is completed actually. The user can grasp that, when he requires the forwarding completion mail, the forwarding of the parcel is completed actually upon confirming mail informed to mail address specified beforehand.

It should be noted that the above-described third embodiment is the preferable embodiment of the present invention, so that the present invention is not limited thereto. For instance, when the facsimile apparatus 33 or the fixed telephone set 34 shown in FIG. 6 transmits a forwarding requirement of the parcel, the operator 25 can cope with each requirement.

In addition, it is possible to further improve convenience for the user upon performing not only specification of the address-for-delivery but also addition of information such as desired time for delivery.

In addition, the above-described embodiment indicates the flow that the control center issues delivery instruction to the delivery car via the delivery control center (delivery trader), however it is preferable to issue the delivery instruction to the delivery car from the control center directly upon concluding the contract between the control center and the delivery trader.

Further, it is possible to change the location of the parcel stored in the specified locker once to an additional locker or different place, because it is possible to access the Web site managed and administered by the control center at arbitrary timing of the user.

As is clear from the above explanation, according to the delivery system of the parcel stored in the locker of the third embodiment, it is possible to provide the user friendly locker system while further improving convenience for the user, upon enabling the parcel (home delivery parcel) stored in the locker once to be forwarded for an additional location required by the user according to simple procedures or a simple system.

(Fourth Embodiment)

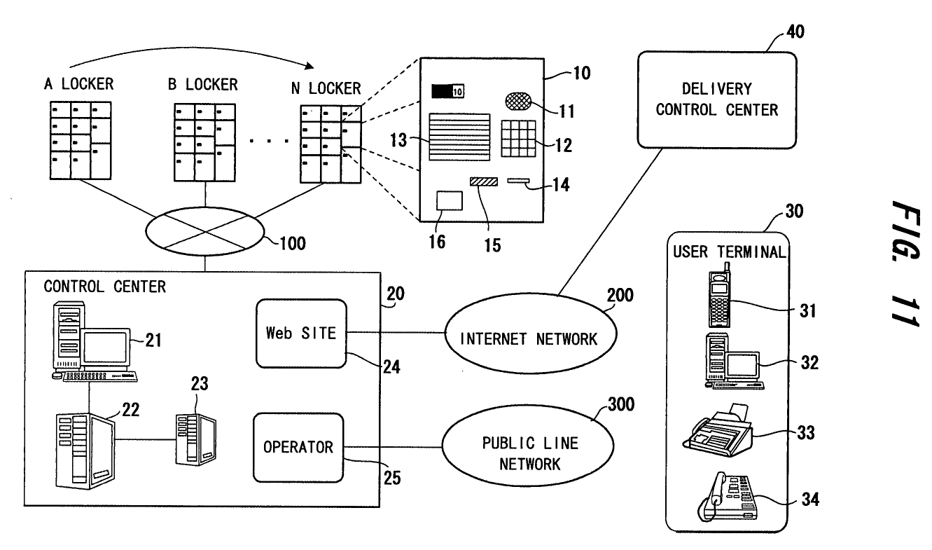

There will be described a reservations specification system of home delivery locker of an address-for-delivery according to a fourth embodiment of the present embodiment with reference to accompanying drawings in detail below. FIGS. 11 to 17 show the reservations specification system of the home delivery locker of the address-for-delivery according to the fourth embodiment of the present invention.

FIG. 11 is a block diagram showing rough configuration of the reservations specification system of the home delivery locker of the address-for-delivery according to the fourth embodiment of the present invention.

In FIG. 11, the reservations specification system of the home delivery locker of the address-for-delivery according to the fourth embodiment of the present invention is comprised of a plurality of locker group A to N, a control center 20 connected to the plurality of locker group A to N via a communication line network 100 (leased line, or public line), a user terminal 30, and a cooperation Web site 40 which cooperates with the control center 20, capable of accessing thereto via an internet network 200.

The locker 10 is provided with a telephone mouthpiece 11 for making the telephone call with the operator 25 of the control center 20, an operation key group 12 for performing specification of the address-for-delivery or taking out of the parcel, a display 13 for displaying various kinds of information such as operation instructions and so forth from the control center 20, a card loading slot 14 for inserting a card (IC card, magnetic card or so forth) for certificating the operator at the time the operator leaves the parcel on check at the locker or the operator performs taking out of the parcel from the locker, a bar code scan slot 15 for scanning the bar code added to the delivery ticket, and receipt issuance opening 16 for issuing receipt (delivery ticket) indicating completion of the work for leaving the parcel on check at the locker.

The control center 20 is comprised of a center terminal 21, a database server 22 and a backup server 23. In addition, this control center 20 is provided with a Web site 24 for performing forwarding service of the parcel and an operator 25 for performing a reception according to telephone function mounted on the locker 10.

The center terminal 21 observes, in real time, information of an installation location or a contact address or so forth of a plurality of locker group A to N, personal information (legal name, room number, telephone number, and so forth) of an utilization contractor, locker utilization circumstances at present, anticrime control, and so forth. The database server 22 associates the circumstances observed by the center terminal 21 with the time information to store therein. The backup server 23 stores the same information as that stored in the database server 22, in an emergency, even though interference occurs on the database server 112, the system itself does not become down state because of the backup server 23.

The user terminal 30 is of, for instance, a portable telephone (PDA is possible) 31 or a personal computer terminal 32 capable of accessing the Web site 24 managed and administrated by the control center 20 or the cooperation Web site 40, connected via the internet network 200, as well as a facsimile apparatus 33 or a fixed telephone set 34 or so forth capable of communicating with the operator 25 of the control center 20 via the public line network 300.

The cooperation Web site 40 is of an online shopping site or a net auction site that is involved in the cooperation with the control center 20 beforehand. The user accesses, when specifying the locker as the address-for-delivery of merchandize that is purchased or that is obtained by successful bidding, the Web site 24 that is managed and administered by the control center 20, after accessing the cooperation Web site 40 from the portable telephone 31 or the personal computer terminal 32 via the internet network 200.

### FIRST OPERATION EXAMPLE

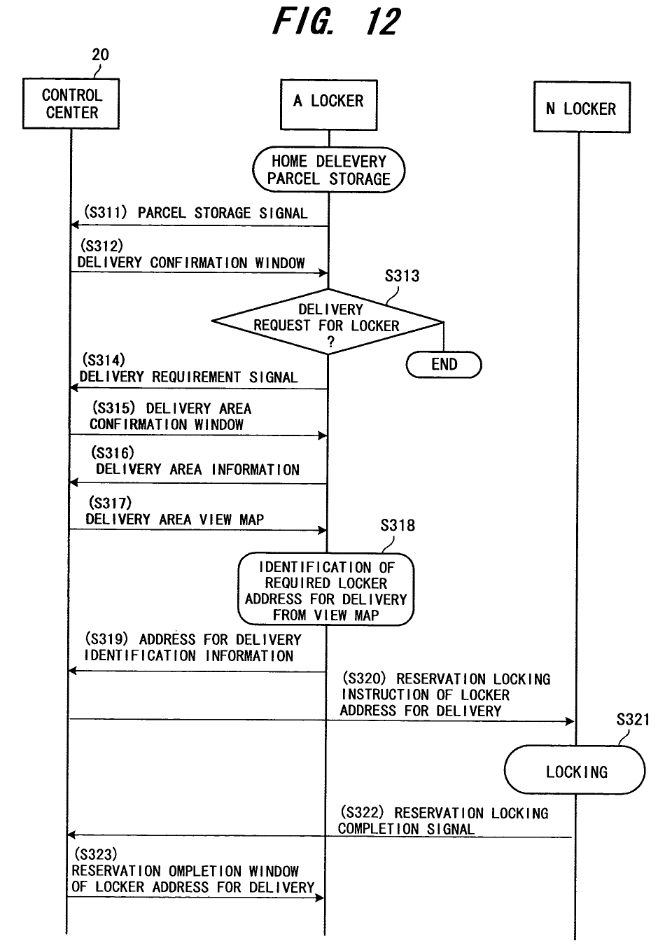

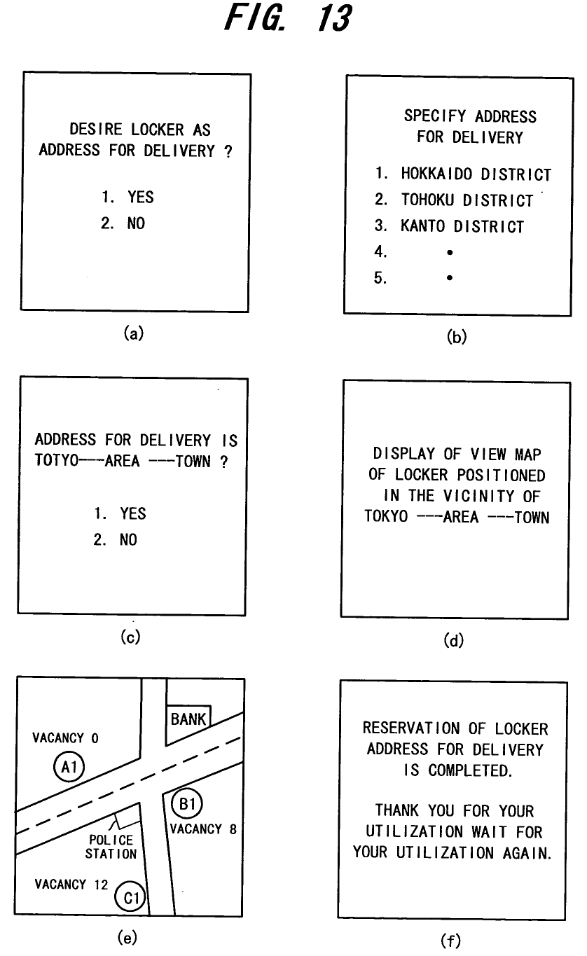

FIG. 12 is a sequence chart showing the first operation example of the reservations specification system of the home delivery locker of the address-for-delivery according to the fourth embodiment of the present invention. The present operation example explains the case that the user himself selects a locker (referred to as locker N) as the address-for-delivery of the parcel, which is installed at a different place from a locker (referred to as locker A) at which the user leaves the parcel on check once. It should be noted that the user of the present system has concluded utilization contract of the present system beforehand with the control center 20. In addition, FIG. 13 shows display example of the locker A in the present operation example.

Firstly, the locker A transmits, when the user leaves the parcel on check at the locker A, a parcel storage signal indicating that the parcel is stored in the locker A to the control center 20 (STEP S311)

The control center 20 transmits, when receiving the parcel storage signal from the locker A to which the parcel is stored, a confirmation window for confirming an address-for-delivery of the parcel to the locker A (STEP S312). FIG. 13(a) shows one example of this confirmation window of the address-for-delivery.

The locker A transmits, when the user desires an additional locker as the address-for-delivery (STEP S13/YES) on the confirmation window of the address-for-delivery displayed on the display of the locker A, a delivery requirement signal to the control center 20 from the locker A upon selecting “1. YES” on the window (STEP S314).

It should be noted that when the user does not desire to select an additional locker as the address-for-delivery, processing is made to terminate (STEP S313/NO) upon selecting “2. NO” on the window. When the user desires to specify the address-for-delivery using an input of dwelling place, it is preferable to transmit the input window of the dwelling place of the address-for-delivery from the control center 20.

The control center 20 transmits, when the delivery requirement signal of “specify a locker as an address-for-delivery” transmitted from the locker A is transmitted, a confirmation window of the district-for-delivery for confirming that the required district-for-delivery by the user is which location to the locker A (STEP S15). FIG. 13(b) shows one example of this confirmation window of the district-for-delivery.

The confirmation window of the district-for-delivery displayed on the display of the locker A shown in FIG. 13(b) displays a plurality of names of district as the district-for-delivery of the parcel, and the information has hierarchical structure such as “name of a district→name of prefectures→name of a city→name of a house number”, therefore, it is possible to simply specify the district-for-delivery. The user can narrow down the district-for-delivery from among alternatives displayed, therefore, it is possible to reduce labor hour for inputting the dwelling place remarkably. In addition, as shown in FIG. 13(c), it is preferable to transmit the confirmation window of information contents narrowed down as the district-for-delivery.

The information narrowed down in such a way as above is transmitted to the control center 20 from the locker A as the district information for delivery (STEP S316). In addition, it is preferable to adopt a method that the user himself inputs information of an address-for-delivery. However, it is preferable to cause information and so forth of the address-for-delivery utilized frequently to be memorized in, for instance, an IC card or a magnetic card so as to enable the selection specification of the home delivery locker of the address-for-delivery to be performed, so that it is possible to perform the selection specification of the home delivery locker of the address-for-delivery upon only inserting the card to the locker A.

The control center 20 extracts, when receiving the information of the district-for-delivery transmitted from the locker A, data of the locker existing in the district specified by the above information of the district-for-delivery from among the data stored in the database server 22, then generates a view map including installation location of the lockers and current utilization circumstances thereof to transmit to the locker A (STEP S317).

As shown in FIG. 13(d), the display of the locker A displays, during the period when the control center 20 forms the view map, a message to the effect that the view map of the locker existing in the district-for-delivery specified by the user will be displayed, and then the view map window shown in FIG. 13(e) is displayed.

The respective lockers indicated on this view map have locker IDs (A1, B1, C1 and so forth) that are of different alphabetical letters or numerical characters. The user is capable of specifying, when specifying the home delivery locker of the address-for-delivery, the address-for-delivery efficiently in that it is not necessarily to perform detailed input specification, upon inputting these locker IDs. In addition, it is possible to secure the locker as the address-for-delivery surely because the respective lockers displayed on the view map display simultaneously current vacant circumstances.

When the user specifies the required home delivery locker of the address-for-delivery form the view map window displayed on the display of the locker A (STEP S318), the locker A transmits this specified information to the control center 20 as identification information of the address-for-delivery (STEP S319).

The control center 20 transmits, based on the identification information of the address-for-delivery transmitted from the locker A, a reservations locking instruction of the corresponding locker (locker N) to the locker N (STEP S320). The locker N executes locking processing in accordance with the reservations locking instruction from the control center 20 (STEP S321), then transmits a reservations locking completion signal indicating to the effect that reservations locking is completed to the control center 20 (STEP S322).

It should be noted that, when there is no vacant locker at the locker N of the address-for-delivery specified by the user, it is preferable to adopt a method to transmit message for urging the user to specify additional locker, or to introduce additional locker group positioned in the vicinity of the locker specified by the user.

The control center 20 transmits, when receiving the reservations locking completion signal from the locker N, a utilization reservations operation completion window of the home delivery locker of the address-for-delivery (locker N) to the locker A to which the parcel is stored (STEP S323). FIG. 13(f) shows this utilization reservations operation completion window. In such a way as above, it is possible to perform selection specification of the home delivery locker of an address-for-delivery.

It should be noted that the present operation example specifies a locker as an address-for-delivery, however it is preferable to adopt a pattern to input required address so as to display the input neighboring map information.

In such a way as above, when the home delivery locker of the address-for-delivery is selected and specified, (not shown) it is possible to perform delivery of the parcel for the address-for-delivery specified by the user, upon issuing instructions to a transport company or the home delivery trader or so forth from the control center 20 to the effect that the parcel stored in the locker A is made to deliver to the locker N after the collection of cargo by using the Web site or the telephone. It should be noted that, when performing collection of cargo of the parcel stored in the locker A, it is preferable to perform unlocking of the locker A by using the pass word or the ID card, upon issuing the pass word or the ID card at the time of the business cooperation between the control center 20 and the transport company or the home delivery trader beforehand.

### SECOND OPERATION EXAMPLE

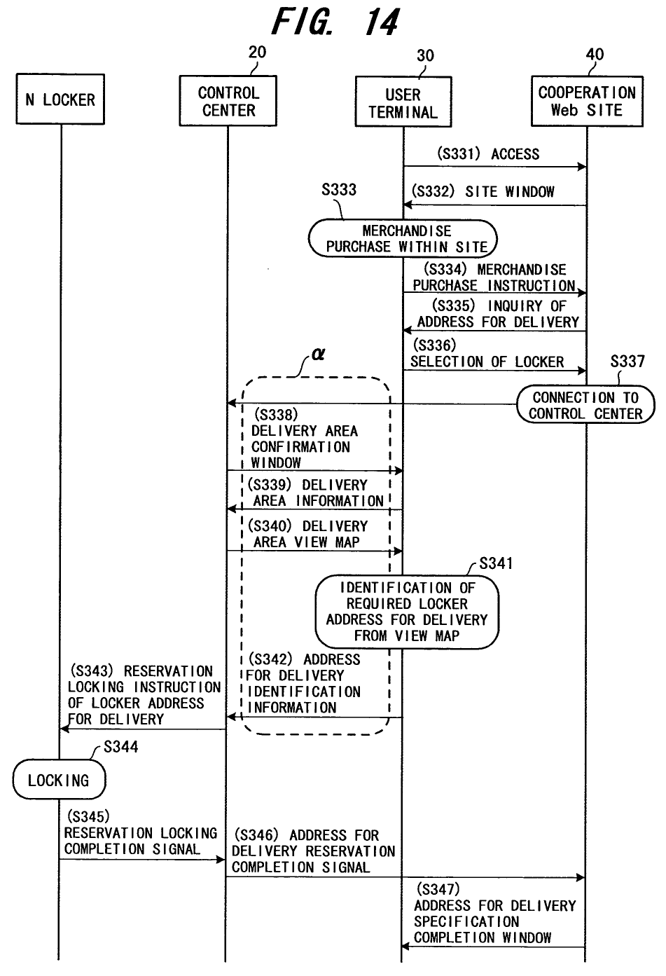

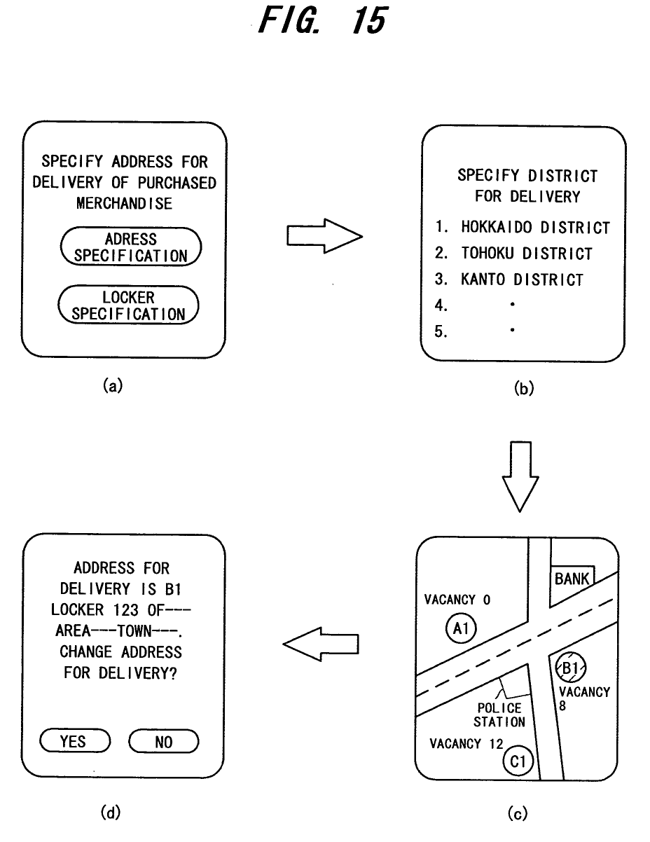

FIG. 14 is a sequence chart showing the second operation example of a reservations specification system of the home delivery locker of the address-for-delivery according to a fourth embodiment of the present invention. The present operation example explains the case that the user accesses a site (hereinafter referred to as cooperation Web site 40) that is cooperated with the control center 20, and selects a locker (referred to as locker N) as an address-for-delivery of merchandise purchased on the site from the user terminal. It should be noted that the cooperation Web site 40 in the present system is involved in utilization contract of the present system with the control center 20 beforehand, and the user himself is necessarily no need of conclusion of utilization contract. In addition, FIG. 15 shows display example of the case that the portable telephone is made to use as the user terminal in the present operation example.

Firstly, the user accesses the cooperation Web site 40 from the user terminal 30 (STEP S331). The user terminal 30 displays, when the access is completed, a site window (home page) of the cooperation Web site 40 (STEP S332). The user purchases required merchandize on the site of an online shopping or a net auction or so forth while performing operations such as a search and so forth on this site window (STEP S333).

The user terminal 30 transmits, when the user indicates a will of purchase on the site window, a merchandize purchase instruction to the cooperation Web site 40 from the user terminal 30 (STEP S334). Concerning this matter, the cooperation Web site 40 inquires user information or a method of payment as well as an address-for-delivery of the merchandize (STEP S335).

FIG. 15(a) shows a window example for inquiring an address-for-delivery of the merchandize. As shown in FIG. 15, the user terminal 30 (portable telephone) displays, when purchasing merchandize while utilizing the cooperation Web site 40, a window such as “address specification” or “locker specification” that is displayed as inquiry of an address-for-delivery of the merchandize. The user, who has confirmed this window, selects “address specification” when the user desires to specify location with the exception of a locker, while when the user desires to specify a locker installed in the vicinity of the company as a address-for-delivery, the user selects “locker specification”.

Here, the user terminal 30 transmits that, when “locker specification” is selected, a locker is selected as an address-for-delivery of merchandize to the cooperation Web site 40 (STEP S336).

The cooperation Web site 40 executes, when receiving the signal to the effect that the user has selected the locker as the address-for-delivery of merchandize from the user terminal, the communication to the control center 20 which is involved in the business cooperation with the cooperation Web site 40 (STEP S337). It should be noted that this communication means that the user terminal 30 is connected to the control center 20 via the cooperation Web site 40. The control center 20 executes, when the cooperation Web site 40 attempts to access the control center 20, certification management whether or not this cooperation Web site 40 is one which concludes the utilization contract of the present system with the control center 20.

The control center 20 transmits, when certifying that the cooperation Web site 40 is the system utilization contractor, a confirmation window of the district-for-delivery which is the window for confirming that the district-for-delivery required by the user is which location to the user terminal 30 (STEP S338). FIG. 15(b) shows one example of this confirmation window of the district-for-delivery.

Similar to the display example shown in FIG. 13(b), the confirmation window of the district-for-delivery displayed on the display of the portable telephone shown in FIG. 15(b) displays a plurality of names of district as the district-for-delivery of the parcel. The information has hierarchical structure such as “name of a district→name of prefectures→name of a city→name of a house number”, therefore, it is possible to simply specify the district-for-delivery.

The user terminal 30 transmits the information narrowed down in such a way as above to the control center 20 as the information of the district-for-delivery (STEP S39).

The control center 20 extracts, when receiving the information of the district-for-delivery transmitted from the user terminal 30, data of lockers existing in the district specified by the information of the district-for-delivery from among data stored in the database server 22. The control center 20 generates a view map capable of indicating installation location of these lockers and current utilization circumstances in order to transmit toward the user terminal 30 (STEP S340) The display of the user terminal 30 displays the view map window shown in FIG. 15(c).

Similar to the first operation example described above, on the view map window shown in FIG. 15(c), the respective lockers have locker IDs (A1, B1, C1 and so forth) that are of different alphabetical letters or numerical characters. The user is capable of selecting to specify, when specifying the locker as the address-for-delivery, the vacant locker surely as the home delivery locker of the address-for-delivery upon using these locker IDs. It should be noted that the user can confirm visually the positional information of the lockers in that the positional information is displayed as the view map, however it is preferable to display the positional information as address information.

The user terminal 30 transmits, when the user specifies the required home delivery locker of the address-for-delivery from the view map window displayed on the display of the user terminal 30 (STEP S341), the specified information as the specification information of the address-for-delivery to the control center 20 (STEP S342).

It should be noted that the operations (α) of STEP S38 to S42 seem like the fact that the user terminal 30 transmits a communication directly to the control center 20, however the user terminal 30 performs actually data communication to the control center 20 via the cooperation Web site 40.

The control center 20 transmits reservations locking instructions of the corresponding locker (locker N) based on identification information of the address-for-delivery transmitted from the user terminal 30 (STEP S343). The locker N transmits, after executing the locking processing operation in accordance with the reservations locking instruction from the control center 20 (STEP S344), a reservations locking completion signal indicating that the reservations locking operation is completed to the control center 20 (STEP S345).

It should be noted that, when there is no vacant locker at the locker N of the address-for-delivery specified by the user, it is preferable to adopts a method to transmit message for urging the user to specify an additional locker, or to introduce an additional locker group positioned in the vicinity of the locker N specified by the user.

The control center 20 transmits, when receiving the reservations locking completion signal from the locker N, a delivery reservations completion signal indicating that utilization reservations operation of the home delivery locker of the address-for-delivery (locker N) is completed to the cooperation Web site 40 (STEP S346).

The cooperation Web site 40 transmits, when receiving the reservations completion signal of the address-for-delivery from the control center 20, a specification completion window of the address-for-delivery to the user terminal 30 (STEP S347) FIG. 15(d) shows one example of this specification completion window of the address-for-delivery. Thus, it is possible to select to specify the home delivery locker of the address-for-delivery at which the user enables the cooperation Web site 40 to leave the parcel on check surely. In addition, as shown in FIG. 15(d), when the user desires to change the locker to an additional locker although the user specifies the locker as the address-for-delivery once, the user is capable of performing an alteration of the address-for-delivery.

In such a way as above, as explained in the first operation example, when the home delivery locker of the address-for-delivery is selected and specified, it becomes possible to perform the delivery of the merchandize for the locker as the address-for-delivery specified by the user, upon issuing instructions to the transport company or the home delivery trader or so forth from the control center 20 by using the Web site or the telephone.

It should be noted that the above-described embodiment is one of the preferable embodiments of the present invention, so that the present invention is not limited thereto. For instance, when the user causes the facsimile apparatus 33 or the fixed telephone set 34 shown in FIG. 11 to transmit a selection specification change signal of the locker, the operator 25 can cope with each requirement.

In addition, it is possible for the user to further improve convenience upon performing not only specification of the address-for-delivery but also addition of information such as desired time for delivery.

Further, the user is capable of accessing the Web site managed and administered by the control center 20 at arbitrary timing of the user, therefore the user is capable of selecting to change appropriately the locker of the address-for-delivery, when the user desires to forward the parcel stored in the specified locker once for an additional locker.

Furthermore, a cooperation company (for instance, a catalog selling company with conclusion of utilization contract with the control center) can achieve role of the cooperation Web site. In this case, it is preferable for this cooperation company to perform communication with the control center 20 by using the facsimile apparatus 33 or the fixed telephone set 34.

As is clear from the explanation described above, according to the reservations specification system of the home delivery locker of the address-for-delivery of the fourth embodiment of the present invention, when specifying the locker as the address-for-delivery of the parcel or merchandize or so forth, it is possible to secure the locker of the address-for-delivery surely upon performing reservations operation of the available locker, after confirming the installation location and/or the utilization circumstances of the locker as the address-for-delivery. Thus it is possible to provide user-friendly locker system while further improving convenience for the user.

(Fifth Embodiment)

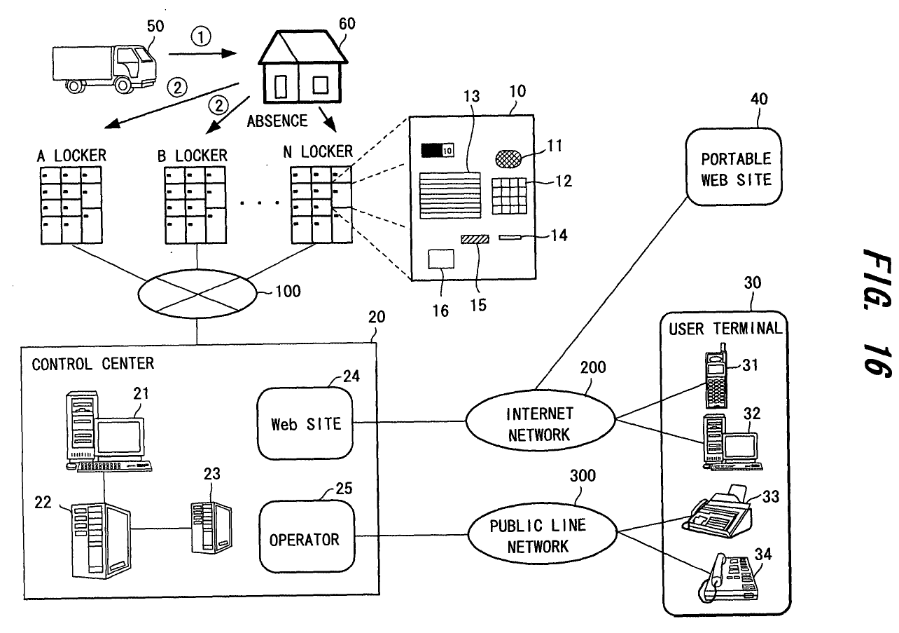

FIG. 16 is a block diagram showing a rough configuration of a reservations specification system of a home delivery locker of an address-for-delivery according to a fifth embodiment of the present invention. The fifth embodiment of the present invention is a system capable of delivering the parcel surely, upon utilizing the home delivery locker installed in the vicinity of the dwelling house of the user, even though the home delivery locker is not installed at the dwelling house of the user who is the parcel recipient. Namely, the parcel recipient can receive the parcel surely at the home delivery locker installed in the vicinity of the dwelling house. In FIG. 16, it should be noted that the same symbol is added to the same configuration element as that indicated in FIG. 11 to omit explanation thereof.

In FIG. 16, the reservations specification system of the home delivery locker of the address-for-delivery according to the fifth embodiment of the present invention is comprised of a plurality of locker group A to N, a control center 20 connected to the plurality of locker group A to N via a communication line network 100 (leased line, or public line), a user terminal 30, a cooperation Web site 40, which cooperates with the control center 20, capable of accessing the control center 20 via an internet network 200, and a delivery car 50. It should be noted that the delivery car 50 (delivery company) of the parcel is involved in the business cooperation with the control center 20.

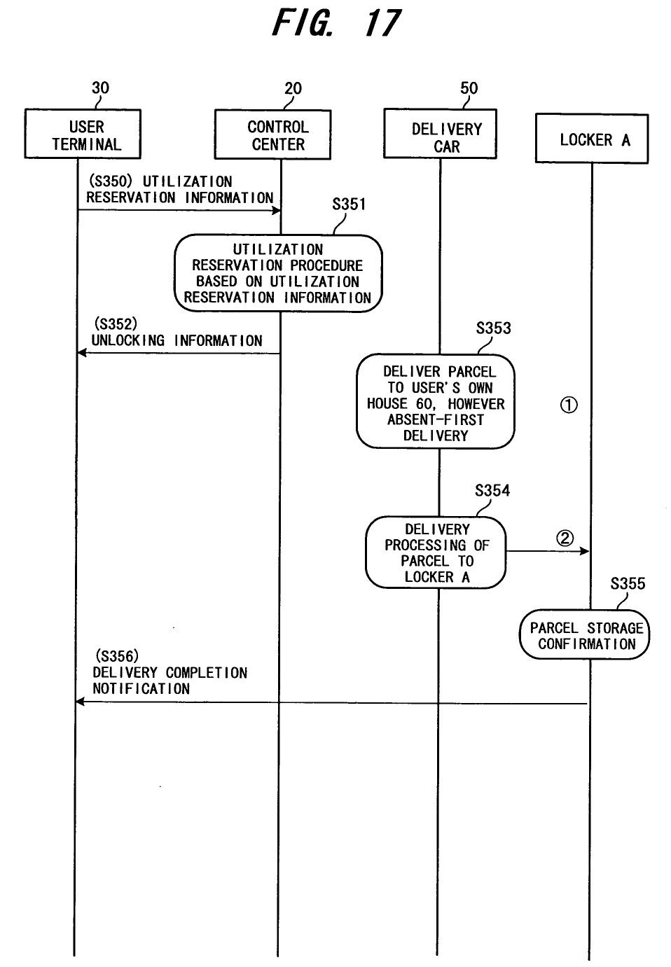

FIG. 17 is a sequence chart showing an operation example of the fifth embodiment of the present invention. Firstly, the user accesses the control center 20 from the user terminal 30 possessed by himself in order to conclude an utilization contract with the control center 20, upon transmitting a utilization reservations information signal so as to cause the home delivery parcel to be delivered to any one of lockers A to N located in the vicinity of the own house 60 as an address-for-delivery with the parcel recipient at absent (STEP S350). It should be noted that, the procedure for utilization contract may be performed by postal procedure.

The control center 20 follows the necessary procedures for the utilization contract with the user based on the utilization reservations information signal transmitted from the user terminal 30 (STEP S351), and then transmits information (unlocking information) necessary for unlocking processing, at the time the user receives the parcel, to the user terminal 30 (STEP S352).

When the delivery person confirms that, when delivering the parcel for the user's own house 60 to be the parcel recipient by the delivery car 50 (first delivery), the user to be the parcel recipient is absent (STEP S353). Then, the delivery person delivers (second delivery) the parcel to the locker A (capable of being specified arbitrarily) as the new address-for-delivery based on the utilization reservations information informed from the control center 20 beforehand (STEP S354).

The locker A accesses, when the parcel is stored, the control center 20 and notifies the user terminal 30 to the effect that the delivery of the parcel is completed based on the utilization reservations information registered by the parcel recipient (also representative of the address-for-delivery is possible) (STEP S355).

It should be noted that the locker A can adopt a configuration wherein the locker A performs down load of information periodically at the time the utilization reservations information is registered to the control center 20.

The user proceeds to, when confirming a delivery completion notification of the parcel transmitted from the control center 20, the installation location of the locker A, and takes out the parcel while performing to unlock the locked locker using information necessary for the unlocking processing notified at the time the utilization reservations procedures beforehand.

It should be noted that, in the above-described fifth embodiment of the present invention, the locker A issues, when the parcel is stored in the locker A, the delivery completion notification signal of the parcel to the user terminal 30, however it is preferable to issue the delivery completion notification signal to the user terminal 30 from the control center 20 based on the utilization reservations information, after reporting the storage completion signal of the parcel to the control center 20 from the locker A.

According to the fifth embodiment of the present invention, although the home delivery locker is not installed at the dwelling house of the user, the user is capable of receiving the parcel while utilizing the home delivery locker installed in the vicinity of the own house with the parcel recipient at absent.

In addition, although the user to be the parcel recipient specifies the user's own house as the address-for-delivery of the merchandize purchased while utilizing the cooperation Web site 40, unfortunately, when the user to be the parcel recipient is absent at the time of the delivery, it is possible to cause the parcel to be delivered to the home delivery locker installed in the vicinity of the own house automatically upon following necessary procedures for concluding the utilization contract beforehand. In this case, actual utilization of the locker involves a charge, however, when the parcel can be delivered to the user's own house, the user has no charge.

According to the reservations specification system of the home delivery locker of the address-for-delivery of the fifth embodiment of the present invention, although the home delivery locker is not installed at the dwelling house of the user, it is possible to perform receiving the parcel while utilizing the home delivery locker installed in the vicinity of the own house with the parcel recipient at absent.

What is claimed is:

1. A locker system comprising: a plurality of lockers provided with predetermined operating means, and a control center for controlling the plurality of lockers, both of which are connected via a communication line network,
wherein a utilization applicant of a locker accesses, when a locker that the utilization applicant desires to utilize is in busy condition among said plurality of lockers, said control center from said predetermined operating means or from an available terminal apparatus for said utilization applicant via said communication line network, and transmits a utilization reservations signal of a locker and a contact address of said utilization applicant as reservations information,
said control center performs, when the locker that said utilization applicant desires to utilize becomes available among said plurality of lockers, utilization reservations operation of the locker, while transmitting locking instruction of the available locker, then notifies that the locker is available to the contact address of said utilization applicant, and
said utilization applicant confirms that the locker is available based on the notification from said control center, then proceeds to an installation location of the corresponding locker, followed by unlocking the locked locker by using said predetermined operating means in order to leave a parcel on check at the locker.

2. The locker system according to claim 1, wherein said control center transmits, when the checked parcel exists in prescribed locker left unattended more than predetermined time, message persuading the contact address of the user of the locker to take out the parcel.

3. A locker system comprising: a plurality of lockers provided with predetermined operating means, and a terminal apparatus available for a utilization applicant of a locker, both of which are connected via a communication line network,
wherein the utilization applicant of the locker transmits, when the locker that the utilization applicant desires to utilize is in busy condition among said plurality of lockers, a utilization reservations signal of the locker and a contact address of the utilization applicant to any one of said plurality of lockers from said predetermined operating means or said terminal apparatus via said communication line network,
each of said plurality of lockers has observing means for observing utilization circumstances of the lockers, and communicating means for communication with said terminal apparatus, in which when said communicating means receives said utilization reservations signal and said contact address via said communication line network, and then, said observing means finds that the locker that the utilization applicant desires to utilize becomes available, followed by reserving the locker while locking the locker, and said communicating means transmits a communication to the effect that the locker is available to said contact address,
said utilization applicant confirms that the locker is available depending on said communicating means, then proceeds to an installation location of the corresponding locker, followed by unlocking the locked locker using said predetermined operating means in order to leave a parcel on check at the locker.

4. The locker system according to claim 3, wherein each of said plurality of lockers transmits, when the checked parcel exists in prescribed locker left unattended more than predetermined time, message persuading the contact address of the user of the locker to take out the parcel, from said communicating means.

5. A locker system comprising: a plurality of lockers provided with predetermined operating means, a control center for consolidating said plurality of lockers, a delivery trader for delivering parcels to predetermined places depending on prescribed means of transportation, and a user terminal possessed by the user, in which said plurality of lockers, said control center, and said user terminal are connected via a communication line, and a parcel stored in an arbitrary locker among said plurality lockers is made to deliver for an address-for-delivery specified by the user,
wherein said user obtains information of the address-for-delivery of the parcel from said control center beforehand, and then specifies an address-for-delivery of the parcel based on the obtained information using said predetermined operating means or said user terminal in order to transmit a communication about the specified address-for-delivery of the parcel to said control center,
said control center instructs said delivery trader on delivery of said parcel for said address-for-delivery from said locker based on the information about an additional location of said address-for-delivery of the parcel specified by said operating means or said user terminal, and
said delivery trader executes collection of cargo of said parcel from the locker, in which the parcel is stored once, by using the transportation means based on the instruction for causing the parcel to be delivered for said additional address-for-delivery of the parcel.

6. The locker system according to claim 5, wherein the information of said address-for-delivery is of address information of said address-for-delivery or map information of said address-for-delivery.

7. The locker system according to claim 5, wherein the information of said address-for-delivery includes, when said address-for-delivery is of an additional locker specified by said user, vacancy information of said additional locker.

8. The locker system according to claim 5, wherein said control center executes, when said address-for-delivery is an additional locker specified by said user, utilization reservations operation of said additional locker.

9. A locker system comprising: a plurality of lockers provided with predetermined operating means, a control center for consolidating said plurality of lockers, and a user terminal possessed by the user, all of which are connected via communication line, in which the user can select previously any one of said plurality of lockers as an address-for-delivery of the parcel which the user himself desires to deliver, and the user can specify to reserve the selected locker,
wherein said user requires to obtain information concerning the locker as the address-for-delivery of the parcel by using said predetermined operating means or said user terminal from said control center, and
said control center transmits, in accordance with the requirement of the user, positional information and utilization circumstances of the locker as the address-for-delivery to said locker or said user terminal so that said user selects to specify the required address-for-delivery of the parcel based on said positional information and utilization circumstances of the locker, thus the user is capable of performing reservations specification of the required home delivery locker of an address-for-delivery of the parcel.

10. The locker system according to claim 9, wherein said control center is connected to a cooperation company apparatus of a cooperation company which is involved in business cooperation with said control center via said communication line, in which said user selects any one of said plurality of lockers as an address-for-delivery of merchandize purchased via said cooperation company apparatus using said user terminal and the user can specify to reserve the selected locker.

11. The locker system according to claim 9, wherein said control center transmits a position of a locker of said address-for-delivery as map information or dwelling place information and transmits utilization circumstances of said locker.

12. A locker system comprising: a plurality of lockers provided with predetermined operating means, a control center for consolidating said plurality of lockers, and a user terminal possessed by the user, all of which are connected via communication line,
wherein said user accesses said control center from said predetermined operating means or said user terminal, and concludes utilization contract of a locker as an address-for-delivery of parcels, with a parcel recipient at absent, based on utilization reservations information,
said control center notifies the delivery company which is involved in business cooperation with the control center of positional information of the locker as the address-for-delivery of the parcel with the parcel recipient at absent,
said delivery company completes, when the parcel recipient of the address-for-delivery is absent at the time of delivery of the parcel, the delivery of said parcel based on the notified positional information of the locker as said address-for-delivery of the parcel, and
said locker notifies, when said parcel is stored, said user terminal that said parcel is stored based on said utilization contract information from said control center.

13. A locker system comprising: a plurality of lockers provided with predetermined operating means, a control center for consolidating said plurality of lockers, and a user terminal possessed by the user, all of which are connected via communication line,
wherein said user accesses said control center from said predetermined operating means or said user terminal, and concludes utilization contract of a locker as an address-for-delivery of parcels, with the parcel recipient at absent, based on utilization reservations information,
said control center notifies the delivery company which is involved in business cooperation with the control center of positional information of the locker as the address-for-delivery of the parcel with the parcel recipient at absent,
said delivery company completes, when the parcel recipient of the address-for-delivery is absent at the time of delivery of the parcel, the delivery of said parcel based on the notified positional information of the locker as said address-for-delivery of the parcel, and
said control center notifies, when confirming that said parcel is stored in said locker, said user terminal that said parcel is stored based on said utilization contract information.
